(19) United States
(12) Patent Application Publication
(10) Pub. No.: US 2012/0052699 A1
(43) Pub. Date: Mar. 1, 2012

(54) INTERPOSER ASSEMBLY FOR ELECTRICALLY CONNECTING ELECTRICAL CABLES TO AN ELECTRONIC MODULE

(75) Inventor: Alan MacDougall, Beaverton, OR (US)

(73) Assignee: Tyco Electronics Corporation, Berwyn, PA (US)

(21) Appl. No.: 12/872,991

(22) Filed: Aug. 31, 2010

(51) Int. Cl. H01R 12/00

(52) U.S. Cl. 439/55

(57) ABSTRACT

An interposer assembly is provided for electrically connecting electrical cables to an electronic module. The interposer assembly includes a printed circuit having an electrical connector configured to electrically connect the printed circuit to the electronic module. A cable organizer is mounted on the printed circuit and includes a dielectric body having a cable side. The cable organizer is configured to hold the electrical cables along the cable side of the body. An electrically conductive ground shield is mounted over the body of the cable organizer. The ground shield includes an outer wall that extends over the cable side of the body of the cable organizer such that the outer wall is configured to extend over the electrical cables.

### BACKGROUND OF THE INVENTION

The subject matter described and/or illustrated herein relates generally to electronic modules, and more particularly, to interposer assemblies for electrically connecting electrical cables to an electronic module.

Electronic modules are used for performing a variety of operations within host systems. Examples of electronic modules include chips, packages, processors, microprocessors, central processing units (CPUs), memories, integrated circuits, application specific integrated circuits (ASIC), and/or the like. An electronic module is sometimes electrically connected to another electronic module within the host system to enable communication between the electronic modules. Electrical cables are sometimes used to electrically connect electronic modules together within the host system. More particularly, ends of the electrical cables may be terminated to the printed circuit (sometimes referred to as a “printed circuit board” or a “circuit board”) of an interposer assembly. The interposer assembly includes an electrical connector that electrically connects the printed circuit of the interposer assembly to a substrate (e.g., a printed circuit) of the corresponding electronic module. The printed circuit of the interposer assembly provides electrical paths from the electrical cables to the electrical connector to electrically connect the electrical cables to the electronic module. Opposite ends of the electrical cables may be electrically connected to the other electronic module via another interposer assembly, such that the electrical cables and interposer assemblies provide electrical paths between the electronic modules. Twin axial cables are one example of cables that are used to electrically connect electronic modules together within a host system, for example to convey differential signals between the electronic modules.

Competition and market demands have continued the trend toward smaller and higher performance (e.g., faster) electronic systems. To achieve such smaller and higher performance systems, it may be desirable to increase the number and/or density of electrical paths between electronic modules within the system. However, it may be difficult to increase the number and/or density of electrical paths between the electronic modules at locations where a relatively high number of electrical paths are routed to a relatively compact component, such as where the electrical cables are terminated to electrical contacts of the printed circuit of the interposer assembly. For example, only a limited amount of space is available on the printed circuit of the interposer assembly. Accordingly, the printed circuit of the interposer assembly may not have room to include more, and/or a higher density of, electrical contacts to accommodate an increased number and/or density of electrical cables. Moreover, increasing the number and/or density of electrical paths on the printed circuit of the interposer assembly may negatively impact the electrical performance of the interposer assembly. For example, the increased number and/or density of electrical paths on the printed circuit of the interposer assembly may necessitate a less than optimal relative arrangement of the various electrical paths along the printed circuit, which may add noise and/or reduce signal transmission rates along the electrical paths.

### BRIEF DESCRIPTION OF THE INVENTION

In one embodiment, an interposer assembly is provided for electrically connecting electrical cables to an electronic module. The interposer assembly includes a printed circuit having an electrical connector configured to electrically connect the printed circuit to the electronic module. A cable organizer is mounted on the printed circuit and includes a dielectric body having a cable side. The cable organizer is configured to hold the electrical cables along the cable side of the body. An electrically conductive ground shield is mounted over the body of the cable organizer. The ground shield includes an outer wall that extends over the cable side of the body of the cable organizer such that the outer wall is configured to extend over the electrical cables.

In another embodiment, an electrical cable assembly includes electrical cables and an interposer assembly for electrically connecting the electrical cables to an electronic module. The interposer assembly includes a printed circuit having an electrical connector configured to electrically connect the printed circuit to the electronic module. The electrical cables are electrically connected to the printed circuit. A cable organizer is mounted on the printed circuit and includes a dielectric body holding the electrical cables. An electrically conductive ground shield is mounted over the body of the cable organizer. The ground shield includes an outer wall that extends over the electrical cables.

In another embodiment, an interposer assembly is provided for electrically connecting electrical cables to an electronic module. The electrical cables have electrical conductors. The interposer assembly includes a printed circuit having an electrical connector configured to electrically connect the printed circuit to the electronic module. The printed circuit further includes electrical contacts that are configured to be electrically connected to corresponding electrical conductors of the electrical cables. A cable organizer is mounted on the printed circuit and includes a dielectric body. The body includes channels that are configured to hold corresponding electrical cables therein. The channels are arranged along the body in alignment with corresponding electrical contacts of the printed circuit.

### BRIEF DESCRIPTION OF THE DRAWINGS

FIG. 1 is an elevational view of a portion of an exemplary embodiment of an electronic system.

FIG. 2 is a perspective view of a portion of an exemplary embodiment of an electrical cable assembly of the electronic system shown in FIG. 1.

FIG. 3 is a perspective view of a portion of the electrical cable assembly shown in FIG. 2 illustrating an exemplary embodiment of a cable terminator assembly of the electrical cable assembly.

FIG. 4 is a perspective view of an exemplary embodiment of a cable organizer of the cable terminator assembly shown in FIG. 3.

FIG. 5 is a plan view of the cable organizer shown in FIG. 4.

FIG. 6 is a perspective view of an exemplary embodiment of a ground shield of the cable terminator assembly shown in FIG. 3.

FIG. 7 is another perspective view of the ground shield shown in FIG. 6 taken from a different angle than FIG. 6.

FIG. 8 is a perspective view of a portion of the electrical cable assembly shown in FIG. 2 illustrating a portion of the cable terminator assembly shown in FIG. 3.

FIG. 9 is a cross-sectional view of a portion of the electrical cable assembly shown in FIG. 3.

FIG. 10 is another cross-sectional view of a portion of the electrical cable assembly shown in FIG. 3.

FIG. 11 is a perspective view of a portion of an exemplary alternative embodiment of an electrical cable assembly illustrating an exemplary alternative embodiment of a cable terminator assembly.

FIG. 12 is an elevational view of an exemplary embodiment of an electrical cable assembly.

FIG. 13 is an elevational view of a portion of an exemplary alternative embodiment of an electrical cable assembly.

### DETAILED DESCRIPTION OF THE INVENTION

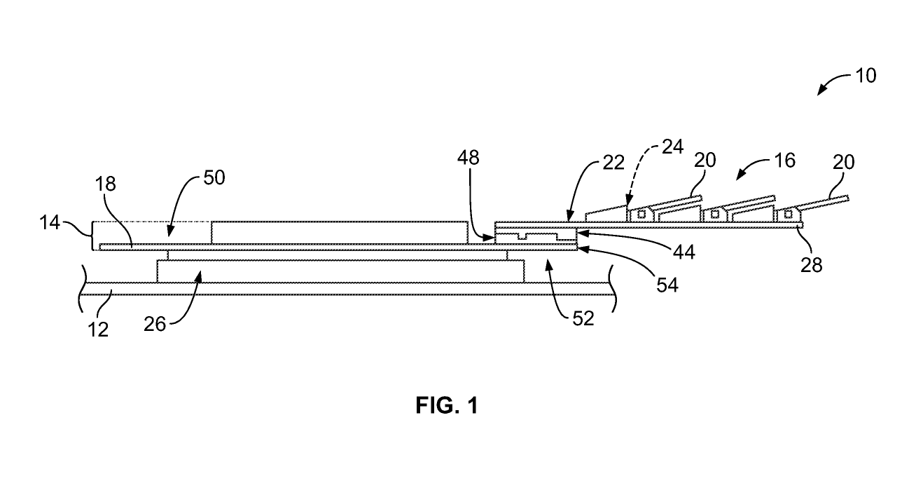

FIG. 1 is an elevational view of a portion of an exemplary embodiment of an electronic system 10. The electronic system 10 includes a mother board 12, an electronic module 14, and an electrical cable assembly 16. The electronic module 14 includes a substrate 18 that is mounted on the motherboard 12 in electrical connection therewith. The electrical cable assembly 16 includes a plurality of electrical cables 20 and an interposer assembly 22 that terminates ends 24 of the electrical cables 20. In the exemplary embodiment, the interposer assembly 22 provides an electrical path between the ends 24 of the electrical cables 20 and the substrate 18 of the electronic module 14 to electrically connect the electrical cables 20 to the electronic module 14.

The electronic module 14 may be any type of electronic module, such as, but not limited to, a chip, a package, a processor, a microprocessor, a central processing unit (CPU), a memory, an integrated circuit, an application specific integrated circuit (ASIC), and/or the like. Optionally, the substrate 18 of the electronic module 14 is a printed circuit. In the exemplary embodiment, the electronic module 14 is mounted on the motherboard 12 using a land grid array (LGA) socket connector 26. However, the electronic module 14 may be mounted on the motherboard 12 using any other structure, means, type of connection, type of connector, and/or the like, such as, but not limited to, a ball grid array (BGA) connector, a connector that is not a socket, and/or the like. In some alternative embodiments, the electronic module 14 is mounted directly on the motherboard 12 without the use of an intervening connector.

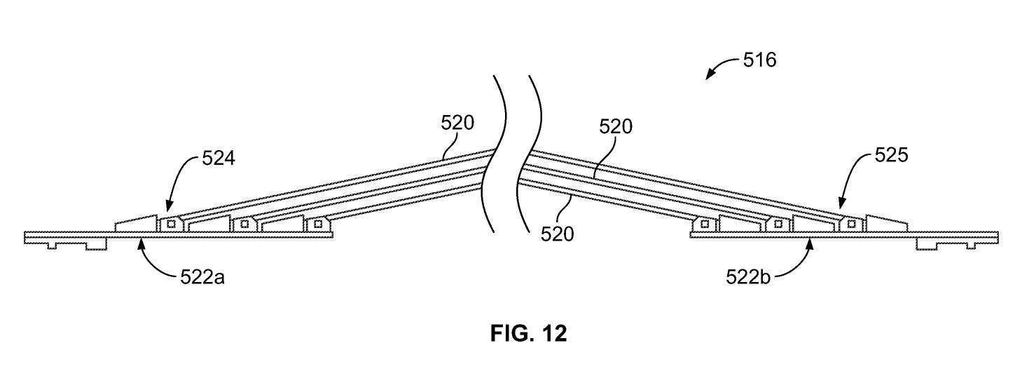

The electrical cables 20 may electrically connect the electronic module 14 to any other component(s) within and/or external to the electronic system 10. Optionally, the electrical cables 20 electrically connect the electronic module 14 to one or more other electronic modules (not shown) within and/or external to the electronic system 10. More particularly, ends (not shown) of the electrical cables 20 that are opposite the ends 24 may be electrically connected to the other electronic module(s), for example via one or more interposer assemblies (not shown) that are substantially similar to the interposer assembly 22. Whether or not the electrical cables 20 electrically connect the electronic module 14 to one or more other electronic modules, the ends of the electrical cables 20 that are opposite the ends 24 may be terminated to another interposer assembly that is substantially similar to the interposer assembly 22. For example, FIG. 12 is an elevational view of an exemplary embodiment of an electrical cable assembly 516 that includes a plurality of electrical cables 520 and two interposer assemblies 522a and 522b. Each electrical cable 520 extends a length from an end 524 to an opposite end 525. The ends 524 of the electrical cables 520 are terminated to the interposer assembly 522a, while the ends 525 of the electrical cables 520 are terminated to the interposer assembly 522b. The interposer assemblies 522a and 522b may each be used to electrically connect the electrical cables 520 to any components within and/or external to an electronic system that includes the electrical cable assembly 516.

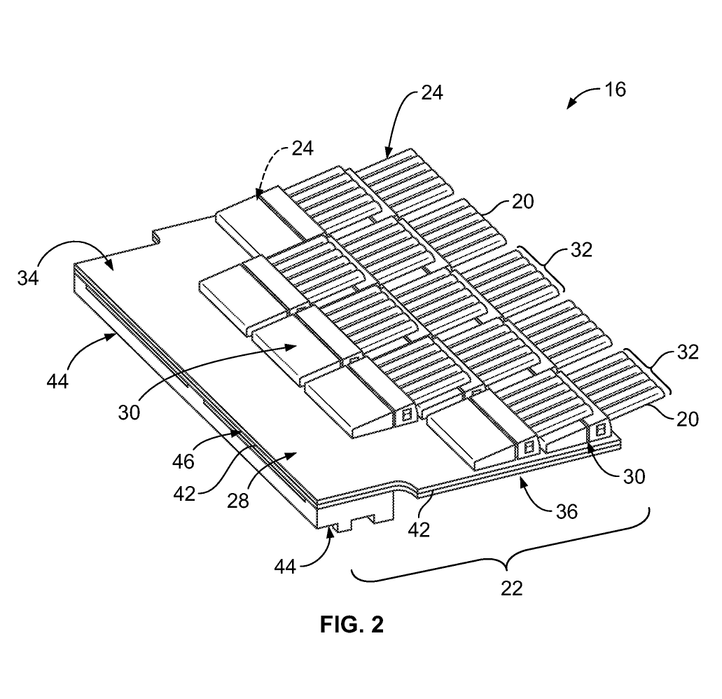

FIG. 2 is a perspective view of a portion of an exemplary embodiment of the electrical cable assembly 16. The electrical cable assembly 16 includes the electrical cables 20 and the interposer assembly 22, which electrically connects the electrical cables 20 to the electronic module 14 (FIG. 1). The interposer assembly 22 includes a printed circuit 28 and one or more cable terminator assemblies 30. Each cable terminator assembly 30 is used to terminate a corresponding group 32 of the electrical cables 20 to the printed circuit 28 of the interposer assembly 22, as will be described below.

The printed circuit 28 of the interposer assembly 22 includes a side 34 and an opposite side 36. In the exemplary embodiment, each of the cable terminator assemblies 30 is mounted on the side 34 of the printed circuit 28 such that each of the cable groups 32 is terminated to the side 34 of the printed circuit 28. Additionally or alternatively, one or more cable terminator assemblies 30 is mounted on the side 36 of the printed circuit 28 such that the corresponding cable group(s) 32 is terminated to the side 36 of the printed circuit 28. Although thirteen cable terminator assemblies 30 are shown for terminating thirteen cable groups 32 to the printed circuit 28 of the interposer assembly 22, the interposer assembly 22 may include any number of cable terminator assemblies 30 for terminating any number of cable groups 32 to the printed circuit 28. Moreover, each cable group 32 may include any number of the electrical cables 20. The interposer assembly 22 may electrically connect any number of cable groups 32 and any number of the electrical cables 20 overall to the electronic module 14.

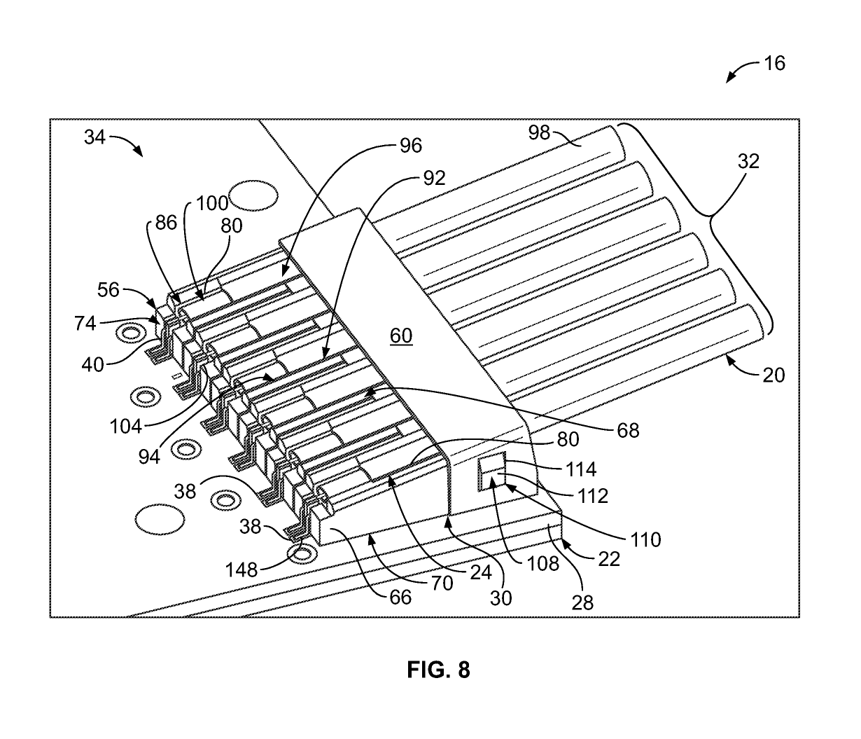

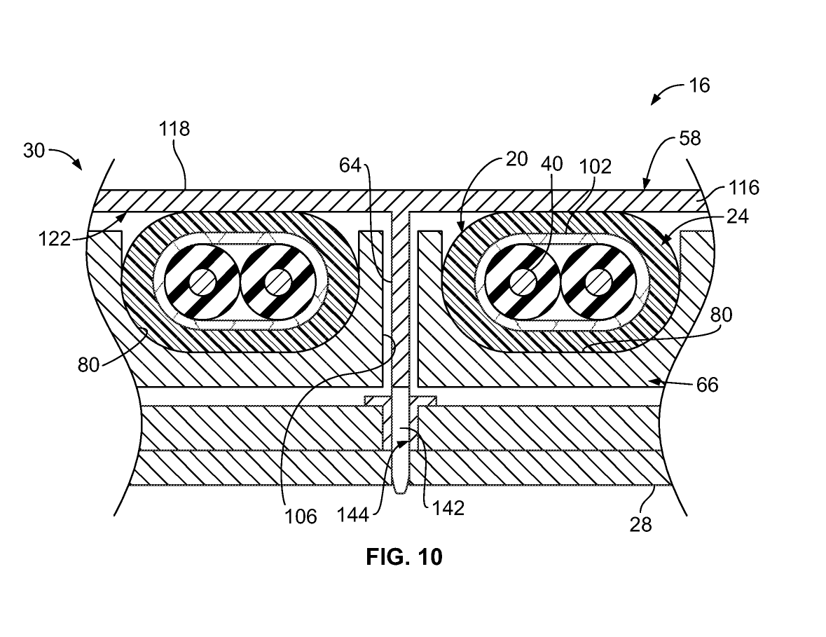

In the exemplary embodiment, the side 34 of the printed circuit 28 includes electrical contacts 38 (FIG. 8) for terminating corresponding electrical conductors 40 (FIGS. 8 and 10) of the electrical cables 20. It should be understood that the side 36 of the printed circuit 28 may include electrical contacts 38 if any electrical cables 20 are terminated to the side 36. Optionally, the printed circuit 28 includes a ground plane, or layer, 42. In the exemplary embodiment, the ground plane 42 is an internal layer of the printed circuit 28 that extends within the printed circuit 28 between the sides 34 and 36. In addition or alternatively, the printed circuit 28 may include a ground plane (not shown) that extends on the side 34 and/or the side 36 of the printed circuit 28, and/or the ground plane 42 may extend on the side 34 and/or the side 36 of the printed circuit 28. The printed circuit 28 may include any number of ground planes. The sides 34 and 36 of the printed circuit 28 may each be referred to herein as an “organizer side”.

The printed circuit 28 of the interposer assembly 22 includes an electrical connector 44 that electrically connects the printed circuit 28 to the substrate 18 (FIG. 1) of the electronic module 14. The printed circuit 28 of the interposer assembly 22 includes electrical paths (not shown) that electrically connect the electrical contacts 38 to the electrical connector 44. The ground plane 42 of the printed circuit 28 is optionally electrically connected to the electrical connector 44 directly and/or through one or more electrical paths (not shown) of the printed circuit 28. Examples of the electrical paths of the printed circuit 28 that electrically connect the electrical connector 44 to the electrical contacts 38 and/or the ground plane 42 include, but are not limited to, electrical traces (not shown) that extend on and/or within the printed circuit 28, internal conductive layers (not shown) of the printed circuit 28, other electrically conductive paths extending on and/or within the printed circuit 28, and/or the like. Although shown as being mounted on the side 36 of the printed circuit 28, the electrical connector 44 may alternatively be mounted on the side 34 of the printed circuit 28. Moreover, in some alternative embodiments, the electrical connector 44 extends over, and/or is mounted to, an edge 46 of the printed circuit 28 that extends from the side 34 to the side 36, whether or not the electrical connector 44 also extends over, and/or is mounted to, the sides 34 and/or 36 of the printed circuit 28. The electrical connector 44 may be any type of electrical connector.

Referring again to FIG. 1, in the exemplary embodiment, the electrical connector 44 mates with a mating connector 48 of the electronic module substrate 18. When mated together, the electrical connector 44 and the mating connector 48 electrically connect the printed circuit 28 of the interposer assembly 22 to the substrate 18 of the electronic module 14. Alternatively, the electrical connector 44 mates directly with the substrate 18 of the electronic module 14 to establish the electrical connection between the interposer assembly 22 and the electronic module 14. For example, in some alternative embodiments, the electrical connector 44 is a connector (such as, but not limited to, a compression connector and/or the like) that mates directly with contact pads (not shown) on the substrate 18. In the exemplary embodiment, the mating connector 48 is mounted on a side 50 of the substrate 18 that generally faces away from the motherboard 12. But, the mating connector 48 may alternatively be mounted on a side 52 of the substrate 18 that is opposite the side 50 and generally faces toward the motherboard 12. Moreover, in some alternative embodiments, the mating connector 48 extends over, and/or is mounted to, an edge 54 of the substrate 18 that extends from the side 50 to the side 52, whether or not the mating connector 48 also extends over, and/or is mounted to, the sides 50 and/or 52 of the substrate 18. The mating connector 48 may be any type of connector that is configured to mate with the electrical connector 44.

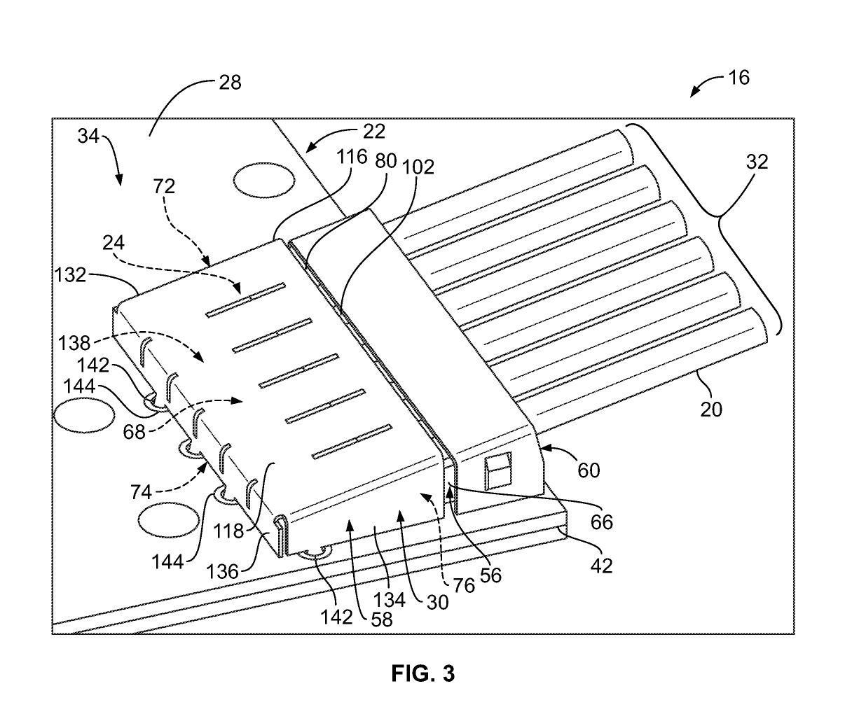

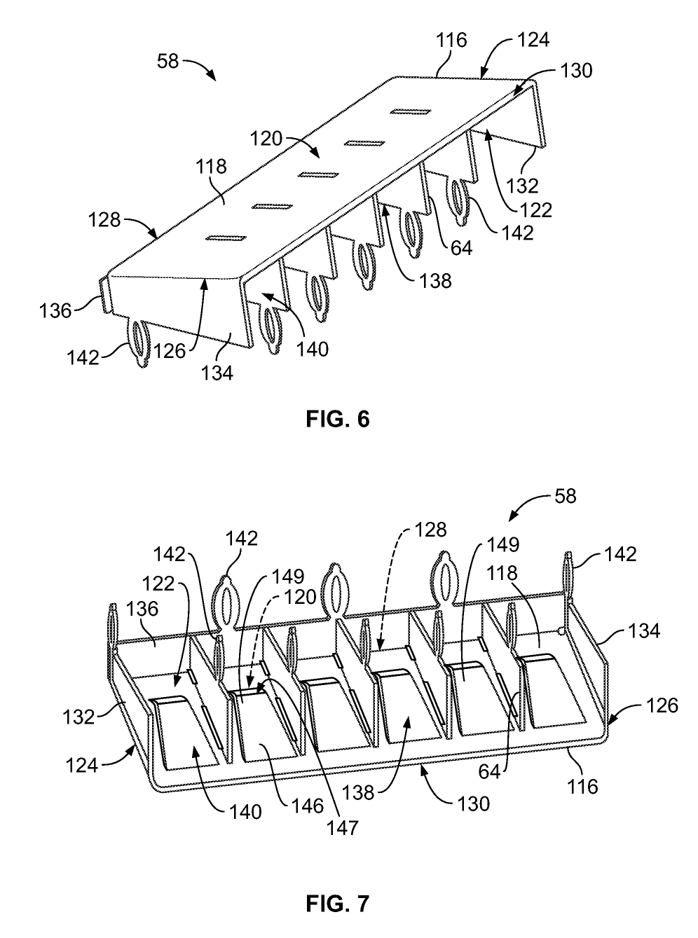

FIG. 3 is a perspective view of a portion of the electrical cable assembly 16 illustrating an exemplary embodiment of one of the cable terminator assemblies 30 of the interposer assembly 22. The cable terminator assembly 30 includes a cable organizer 56, a ground shield 58, and an optional strain relief band 60. The cable organizer 56 is mounted on the printed circuit 28 of the interposer assembly 22. The cable organizer 56 holds and aligns the electrical cable ends 24 of the corresponding cable group 32 with the corresponding electrical contacts 38 (FIG. 8) of the printed circuit 28. The ground shield 58 is mounted over the cable organizer 56 such that an outer wall 118 of the ground shield 58 extends over the ends 24 of the electrical cables 20 held by the cable organizer 56. As will be described below, inner walls 64 (FIGS. 6, 7, and 10) of the ground shield 58 extend between adjacent electrical cables 20 held by the cable organizer 56. The strain relief band 60 is mounted on the cable organizer 56 and extends over the electrical cables 20 held by the cable organizer 56 to provide strain relief to the ends 24 of the electrical cables 20. In addition or alternative to the strain relief band 60, a discrete strain relief member and/or assembly (not shown) may be mounted on the printed circuit 28.

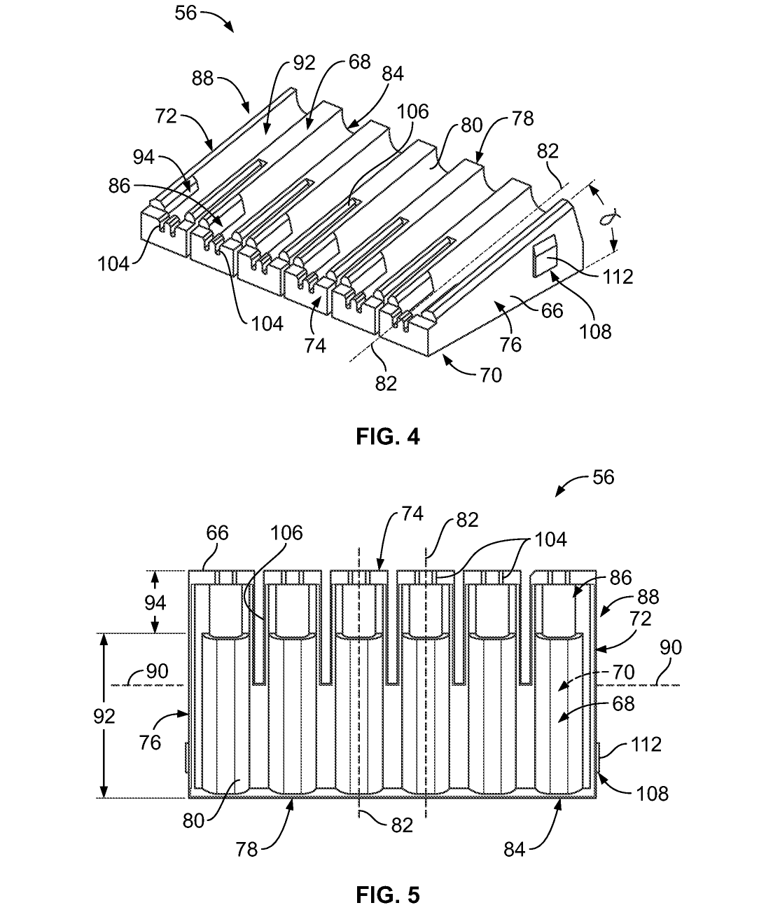

FIG. 4 is a perspective view of an exemplary embodiment of one of the cable organizers 56. FIG. 5 is a plan view of the cable organizer 56. The cable organizer 56 includes a dielectric body 66 that is configured to be mounted on the printed circuit 28 (FIGS. 1-3, 8, and 10). The body 66 includes opposite sides 68 and 70. In the exemplary embodiment, end walls 72, 74, 76, and 78 extend from the side 68 to the side 70. The end walls 72 and 76 extend opposite each other, while the end walls 74 and 78 extend opposite each other. Although the body 66 has the general shape of a parallelepiped in the exemplary embodiment, the body 66 may additionally or alternatively include any other general shape. The side 68 of the body 66 may be referred to herein as a “cable side”. The side 70 of the body 66 may be referred to herein as a “printed circuit side”.

The body 66 of the cable organizer 56 is configured to hold the ends 24 (FIGS. 1-3, 8, and 10) of the corresponding cable group 32 (FIGS. 2, 3, and 8) along the side 68 of the body 66. For example, the body 66 includes one or more channels 80 that extend into the side 68 of the body 66. Each channel 80 is configured to receive the end 24 of a corresponding electrical cable 20 therein such that the channel 80 is configured to hold the corresponding electrical cable end 24 therein. The channels 80 extend lengths along central longitudinal axes 82 from the end wall 78 toward the end wall 74 of the body 66. Each channel 80 extends the length from an end 84 to an opposite end 86. The channels 80 optionally extend through the end wall 78 of the body 66 at the ends 84 of the channels 80. Although six are shown, the body 66 of each cable organizer 56 may include any number of channels 80 for holding the ends 24 of any number electrical cables 20.

The channels 80 are arranged along the side 68 of the body 66 such that each channel 80 is configured to be aligned with one or more corresponding electrical contacts 38 (FIG. 8) of the printed circuit 28. Specifically, when the body 66 of the cable organizer 56 is mounted on the printed circuit 28, the end 86 of each channel 80 is aligned with one or more corresponding electrical contacts 38. In the exemplary embodiment, the lengths of the channels 80 are arranged within a row 88 that extends along the body 66 between the end walls 72 and 76 of the body 66. The row 88 extends along a row axis 90 (not shown in FIG. 4). Within the exemplary arrangement of the row 88, the channels 80 are approximately evenly spaced apart and the central longitudinal axes 82 extend approximately parallel to each other. However, the channels 80 may be arranged in any other pattern, arrangement, and/or the like along the body 66 that aligns the ends 86 with the corresponding electrical contacts 38, including arrangements wherein some or all channels 80 are not approximately evenly spaced apart within a row and/or column and including arrangements wherein some or all of the central longitudinal axes 82 of the channels 80 do not extend approximately parallel to each other.

Each channel 80 optionally includes a shape that is complementary with a shape of the end 24 of the corresponding electrical cable 20. In the exemplary embodiment, the channels 80 include curved shapes that are complementary with twin axial cables that have an oval-shaped periphery. But, each channel 80 may additionally or alternatively include any other shape for receiving an electrical cable end 24 that includes any other shape, whether or not such shapes of the channel 80 are complementary with the corresponding electrical cable end 24. In the exemplary embodiment, the channels 80 include jacket segments 92 and shield segments 94 that have a reduced size relative to the jacket segments 92. The jacket segment 92 of each channel 80 includes the end 84 of the channel 80 and extends from the end 84 toward the shield segment 94. The shield segment 94 of each channel 80 includes the end 86 of the channel 80 and extends from the jacket segment 92 to the end 86. As will be described below, the jacket segment 92 of each channel 80 receives a length 96 (FIG. 8) of the corresponding electrical cable end 24 that includes a cable jacket 98 (FIG. 8), and the shield segment 94 receives a length 100 (FIG. 8) of the corresponding electrical cable end 24 wherein the cable jacket 98 has been removed or was not included. The jacket segment 92 of each channel 80 optionally has a complementary size and shape relative to the size and shape of the periphery of the length 96 of the corresponding electrical cable end 24 that includes the cable jacket 98. Optionally, the shield segment 94 of each channel 80 has a complementary size and shape relative to the size and shape of a ground shield 102 (FIG. 8-10) of the corresponding electrical cable 20 that defines the periphery of the length 100 of the corresponding electrical cable end 24 wherein the cable jacket 98 has been removed or was not included.

As best seen in FIG. 4, in the exemplary embodiment, the side 68 of the body 66 of the cable organizer 56 is generally sloped relative to the side 70 of the body 66. In other words, the side 68 of the body 66 generally extends at an angle α relative to the side 70 of the body 66. As will be described below, the slope of the side 68 of the body 66 relative to the side 70 may facilitate more easily terminating the electrical cable ends 24 to the printed circuit 28.

Referring again to FIGS. 4 and 5, the body 66 includes optional conductor location slots 104 that extend through the end wall 74 and are aligned in fluid communication with corresponding channels 80. Each conductor location slot 104 is configured to receive a corresponding electrical conductor 40 (FIGS. 8 and 10) of the electrical cable end 24 that is held by the corresponding channel 80. In the exemplary embodiment, two conductor location slots 104 are aligned in fluid communication with each channel 80 for receiving two electrical conductors 40 of the corresponding electrical cable 20. However, any number of conductor location slots 104 may be aligned with each channel 80 for receiving any number of electrical conductors 40 of the corresponding electrical cable 20. Each conductor location slot 104 may include any shapes. Optionally, the conductor location slots 104 include sizes and/or shapes that are complementary with the size and/or shape of the corresponding electrical conductor 40. Each channel 80 may alternatively extend through the end wall 74 of the body 66.

In the exemplary embodiment, the body 66 of the cable organizer 56 includes slots 106 that extend into the side 68 of the body 66. The slots 106 extend into the body 66 between adjacent channels 80 within the row 88. Each slot 106 receives a corresponding inner wall 64 (FIGS. 6, 7, and 10) of the corresponding ground shield 58 (FIGS. 3, 6, 7, 9, and 10) therein, as will be described below. The slots 106 optionally extend through the end wall 74 of the body 66. The slots 106 optionally extend through the side 70 of the body 66. Although only a single slot 106 is shown extending between adjacent channels 80 within the row 88, any number of slots 106 may extend between adjacent channels 80 within the row 88.

The body 66 of the cable organizer 56 includes one or more optional retention features 108 that cooperate with one or more retention features 110 (FIG. 8) of the strain relief band 60 for holding the strain relief band 60 (FIGS. 3 and 8) on the body 66. In the exemplary embodiment, the retention features 108 include extensions 112 that are received within openings 114 (FIG. 8) of the retention features 110. Alternatively, one or more of the retention features 108 includes an opening (not shown) that receives an extension (not shown) of the retention features 110 therein. Although two are shown, the body 66 may include any number of the retention features 108. Moreover, in addition or alternatively to the end walls 72 and/or 76, the retention features 108 may each be located at any other location along the body 66. The retention features 108 and 110 may each additionally or alternatively include any other structure besides the respective extension 112 and openings 114 for holding the strain relief band 60 on the cable organizer body 66.

FIG. 6 is a perspective view of an exemplary embodiment of one of the ground shields 58. FIG. 7 is another perspective view of the ground shield 58 taken from a different angle than FIG. 6. The ground shield 58 includes an electrically conductive body 116 that is configured to be mounted over the body 66 (FIGS. 3-5 and 8-10) of the corresponding cable organizer 56 (FIGS. 3-5, 8, and 10). The body 116 includes an outer wall 118 having an outer side 120 and an inner side 122. The outer wall 118 extends from an end 124 to an opposite end 126, and from an end 128 to an opposite end 130. In the exemplary embodiment, side walls 132, 134, and 136 extend from the outer wall 118. More particularly, the side walls 132 and 134 extend outwardly from the opposite ends 124 and 126, respectively, of the outer wall 118, while the side wall 136 extends outwardly from the end 128 of the outer wall 118. The side walls 132 and 134 extend opposite each other. Optionally, the body 116 of the ground shield 58 includes a side wall (not shown) that extends outwardly from the end 130 of the outer wall 118 opposite the side wall 136. In embodiments wherein the body 116 includes such a side wall that is opposite the side wall 136, such a side wall may include one or more openings that enable the corresponding electrical cables 20 to pass through such a side wall. The body 116 of the ground shield 58 optionally includes a size and/or shape that is complementary with the size and/or shape of the body 66 of the corresponding cable organizer 56. The body 116 of the ground shield 58 may additionally or alternatively include any other general shape than the shape shown and described in the exemplary embodiment. In some embodiments, the body 116 of the ground shield 58 is fabricated using a stamping or cutting process. For example, the body 116 of the ground shield 58 may be stamped and formed from a flat metal strip. However, the body 116 of the ground shield 58 may be fabricated using any process, means, method, and/or the like. Moreover, the body 116 of the ground shield 58 may include any materials, whether or not all of such materials are electrically conductive. For example, in some embodiments, the body 116 of the ground shield 58 includes a dielectric material that is at least partially covered by an electrically conductive material, or vice versa.

The ground shield 58 includes an interior chamber 138 defined by the outer wall 118 and the side walls 132, 134, and 136. The interior chamber 138 is configured to receive at least a portion of the body 66 of the corresponding cable organizer 56 therein when the body 116 of the ground shield 58 is mounted over the body 66 of the cable organizer 56. The outer wall 118 of the ground shield 58 is configured to extend over the side 68 of the body 66 of the corresponding cable organizer 56 when the body 116 of the ground shield 58 is mounted over the body 66 of the cable organizer 56. In the exemplary embodiment, the side walls 132, 134, and 136 are configured to extend over the end walls 72, 76, and 74 (FIGS. 3-5), respectively, of the body 66 of the corresponding cable organizer 56 when the body 116 of the ground shield 58 is mounted over the body 66 of the cable organizer 56.

The body 116 of the ground shield 58 includes the inner walls 64, which extend outwardly from the inner side 122 of the outer wall 118. The inner walls 64 divide the interior chamber 138 of the ground shield 58 into a plurality of tunnels 140. The tunnels 140 are configured to receive the ends 24 (FIGS. 1, 3, 8, and 10) of corresponding electrical cables 20 (FIGS. 1-3 and 8-10) therein. As will be described below, the inner walls 64 are configured to be received within the slots 106 (FIGS. 4, 5, and 10) of the body 66 of the corresponding cable organizer 56 when the ground shield 58 is mounted over the cable organizer 56. Although the exemplary embodiment includes five inner walls 64 that divide the interior chamber 138 into six tunnels 140, the body 116 of the ground shield 58 may include any number of inner walls 64 for dividing the interior chamber 138 into any number of tunnels 140. Moreover, each tunnel 140 may be configured to receive any number of electrical cable ends 24 therein.

Optionally, the body 116 of the ground shield 58 includes electrical contacts 142 for electrically connecting the body 116 to the printed circuit 28 (FIGS. 1-3, 8, and 10) of the interposer assembly 22 (FIGS. 1-3 and 8). For example, the body 116 of the ground shield 58 may be electrically connected to the ground plane 42 (FIGS. 2 and 3) of the printed circuit 28. Some or all of the electrical contacts 142 may directly engage the ground plane 42 to establish an electrical connection between the body 116 and the ground plane 42. In addition or alternative, some or all of the electrical contacts 142 may be electrically connected to the ground plane 42 through intervening electrical contacts of the printed circuit 28. In the exemplary embodiment, the electrical contacts 142 are eye-of-the needle compliant pins and the printed circuit 28 includes intervening electrical contacts in the form of electrically conductive vias 144 (FIG. 3) that receive the eye-of-the needle compliant pins therein in a press-fit manner. Moreover, in addition or alternatively, other types of contacts besides press-fit pins may be used for the electrical contacts 142 (whether or not the electrical contacts 142 engage the ground plane 42 or are electrically connected to the ground plane 42 through intervening electrical contacts of the printed circuit 28), such as, but not limited to, surface mount contacts, solder tails, and/or the like. Although ten are shown, the body 116 of the ground shield 58 may include any number of the electrical contacts 142.

The body 116 of the ground shield 58 optionally includes electrical contacts 146 that engage the ground shields 102 (FIGS. 8-10) of the corresponding electrical cables 20 to electrically connect the body 116 to the ground shields 102. In the exemplary embodiment, the electrical contacts 146 are resiliently deflectable cantilever beams 149 that include mating interfaces 147 (not visible in FIG. 6) that engage the corresponding ground shields 102. Moreover, in the exemplary embodiment, the outer wall 118 includes the electrical contacts 146. However, in addition or alternative, the inner walls 64 and/or the side walls 132 and/or 134 may include one or more of the electrical contacts 146. Although six are shown, the ground shield 58 may include any number of the electrical contacts 146 for electrical connection to the ground shields 102 of any number of electrical cables 20. In addition or alternative to the resiliently deflectable cantilever beams 149, the electrical contacts 146 may include any other type of contact structure that enables the electrical contacts 146 to electrically connect to the ground shields 102.

FIG. 8 is a perspective view of a portion of the electrical cable assembly 16 illustrating a portion of one of the cable terminator assemblies 30 mounted on the printed circuit 28 of the interposer assembly 22. The ground shield 58 (FIGS. 3, 6, 7, 9, and 10) of the cable terminator assembly 30 has been removed from FIG. 8 for clarity. The body 66 of the cable organizer 56 is mounted on the printed circuit 28 such that the side 70 generally faces the side 34 of the printed circuit 28. In the exemplary embodiment, the body 66 of the cable organizer 56 is heat staked to the printed circuit 28. However, the body 66 may additionally or alternatively be mounted on the printed circuit 28 using any other structure, means, mechanical fastener type, and/or the like, such as, but not limited to, an adhesive, a press-fit connection, an interference-fit connection, a snap-fit connection, a latch, and/or the like.

As can be seen in FIG. 8, the printed circuit 28 includes the electrical contacts 38 that terminate the electrical conductors 40 of the electrical cables 20. In the exemplary embodiment, the electrical contacts 38 are contact pads that extend on the surface of the side 34 of the printed circuit 28. In addition or alternatively to the contact pads, the electrical contacts 38 may include any other type of contact, such as, but not limited to, an electrically conductive or non-electrically conductive via that receives a press-fit pin mounted on an end 148 of the corresponding electrical conductor 40, an electrically conductive or non-electrically conductive via that receives a solder tail mounted on the end 148 of the corresponding electrical conductor 40, an electrically conductive or non-electrically conductive via that receives the end 148 of the corresponding electrical conductor 40, and/or the like.

The body 66 of the cable organizer 56 is mounted on the printed circuit 28 such that the ends 86 of the channels 80 are aligned with the corresponding electrical contacts 38 of the printed circuit 28. In the exemplary embodiment, each of the electrical cables 20 is a twin axial cable that includes two electrical conductors 40. Accordingly, the end 86 of each channel 80 is aligned with two corresponding electrical contacts 38 and two conductor location slots 104 are aligned in fluid communication with each channel 80. The ends 24 of the electrical cables 20 are held within the corresponding channels 80. More particularly, the lengths 96 of the electrical cable ends 24 that include the cable jackets 98 are received within the jacket segments 92 of the corresponding channels 80. Similarly, the lengths 100 of the electrical cable ends 24 wherein the cable jacket 98 has been removed or was not included are received within the shield segments 94 of the corresponding channels 80. The electrical conductors 40 of each electrical cable 20 extend through the corresponding conductor location slots 104 and over the side wall 74 of the cable organizer body 66. Because each conductor location slot 104 is aligned with a corresponding electrical contact 38 of the printed circuit 28, the end 148 of each of the electrical conductors 40 is aligned with the corresponding electrical contact 38. The cable organizer 56 thereby holds and aligns electrical cable ends 24 of the corresponding cable group 32 with the corresponding electrical contacts 38 of the printed circuit 28. The ends 148 of the electrical conductors 40 are terminated to the corresponding electrical contacts 38 of the printed circuit 28 such that the electrical conductors 40 are electrically connected to the corresponding electrical contacts 38. Optionally, the end 148 of one or more electrical conductors 40 is soldered to the corresponding electrical contact 38 of the printed circuit 28.

The cable organizer 56 may facilitate terminating the electrical cable ends 24 to the printed circuit 28 in a less difficult, less costly, and/or less time-consuming manner. For example, by aligning the electrical cable ends 24 with the corresponding electrical contacts 38 and grouping the electrical cable ends 24 relatively closely along the body 66, the cable organizer 56 may enable easier, quicker, and/or lower cost termination of a plurality of electrical cable ends 24 to a relatively dense arrangement of electrical contacts 38. Moreover, and for example, by grouping the electrical cable ends 24 together along the body 66, the cable organizer 56 may enable a plurality of electrical cable ends 24 to be terminated to the printed circuit 28 in a single operation.

As described above, optionally, the side 68 of the cable organizer body 66 is generally sloped relative to the side 70. Accordingly, when the body 66 is mounted on the printed circuit 28, the side 68 is generally sloped, or angled, relative to the side 34 of the printed circuit 28. The slope of the side 68 of the body 66 relative to the side 34 of the printed circuit 28 may facilitate more easily terminating the electrical cable ends 24 to the printed circuit 28. For example, the slope may make it easier to load the electrical cable ends 24 into the corresponding channels 80 without interference from other cable terminator assemblies 30 and/or other components (not shown) mounted on the side 34 of the printed circuit 28.

As shown in FIG. 8, the strain relief band 60 is mounted on the body 66 of the cable organizer 56. The strain relief band 60 extends over the side 68 of the body 66 such that the strain relief band 60 extends over portions of the electrical cable ends 24. The strain relief band 60 provides strain relief to the electrical cable ends 24, which may facilitate preventing inadvertent disconnection of the electrical conductors 40 of the electrical cables 20 from the electrical contacts 38 of the printed circuit 28. As can be seen in FIG. 8, the retention features 108 of the cable organizer body 66 cooperate with the retention features 110 of the strain relief band 60 to hold the strain relief band 60 on the body 66. Specifically, the extensions 112 of the body 66 are received within the openings 114 within the strain relief band 60. The strain relief band 60 may include any number of the retention features 110.

Referring again to FIG. 3, the ground shield 58 is mounted over the body 66 of the cable organizer 56. The body 66 of the cable organizer 56 is received at least partially within the interior chamber 138 of the body 116 of the ground shield 58. The outer wall 118 of the ground shield body 116 extends over at least a portion of the side 68 of the body 66 of the cable organizer 56. The outer wall 118 extends over at least portions of the channels 80 within the body 66 such that the outer wall 118 extends over at least portions of the ends 24 of the electrical cables 20. As should be apparent from FIG. 3, in the exemplary embodiment, the side walls 132 and 134 of the body 116 extend over at least portions of the end walls 72 and 76, respectively, of the cable organizer body 66. Moreover, and in the exemplary embodiment, the side wall 136 of the ground shield body 116 extends over the end wall 74 of the cable organizer body 66. The walls 118, 132, 134, and 136 of the ground shield body 116 facilitate shielding the electrical conductors 40 of the electrical cables 20 from the electrical conductors 40 of other cable groups 32 and/or from other components (not shown) of the system 10 that are external to the cable terminator assembly 30 shown in FIG. 3.

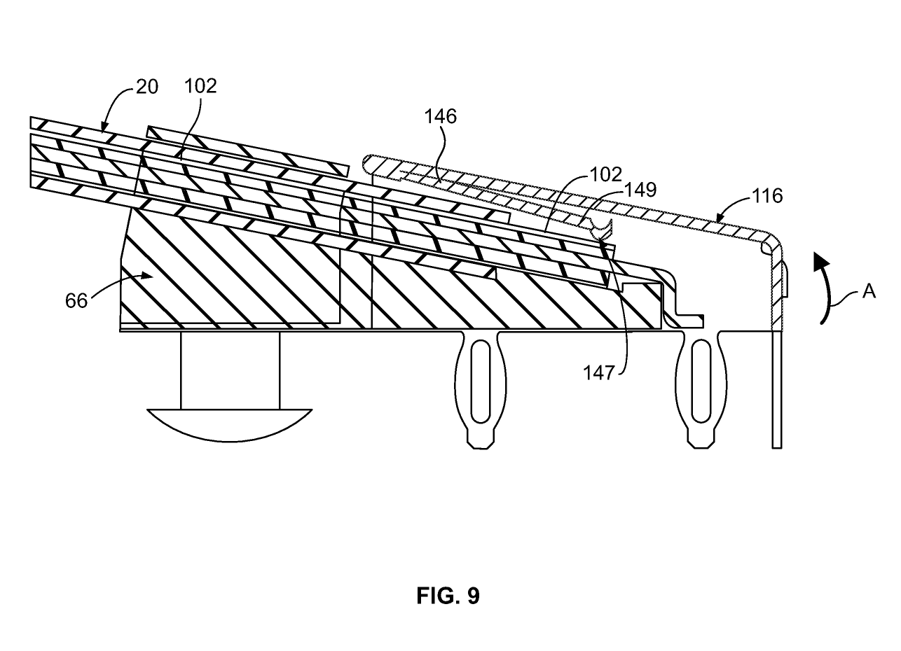

Optionally, the electrical cables 20 include the electrically conductive ground shields 102 that extend around the electrical conductors 40 (FIGS. 8 and 10). The mating interfaces 147 (FIGS. 7 and 9) of the electrical contacts 146 of the ground shield body 116 are engaged with the ground shield 102 of the corresponding electrical cable 20, which establishes an electrical connection between the outer wall 118 of the ground shield 58 and the ground shields 102 of the electrical cables 20. FIG. 9 is a cross-sectional view of a portion of the electrical cable assembly 16 illustrating engagement of one of the electrical contacts 146 with the ground shield 102 of the corresponding electrical cable 20. As the ground shield body 116 is mounted over the cable organizer body 66, the mating interface 147 of the cantilever beam 149 engages the ground shield 102 of the corresponding electrical cable 20. Engagement between the mating interface 147 and the ground shield 102 deflects the cantilever beam 149, in the direction of the arrow A against a bias thereof, away from the natural resting position of the cantilever beam 149. The bias of the cantilever beam 149 toward the natural resting position provides a normal force that facilitates providing a stable and reliable electrical connection between the electrical contact 146 and the ground shield 102. The ground shields 102 may be referred to herein as “cable shields”.

Referring again to FIG. 3, and as described above, the body 116 of the ground shield 58 is optionally electrically connected to the printed circuit 28 of the interposer assembly 22. In the exemplary embodiment, the body 116 is electrically connected to the ground plane 42 of the printed circuit 28. Specifically, the electrical contacts 142 are received within the electrically conductive vias 144 of the printed circuit 28, which are electrically connected to the ground plane 42. The electrical engagement of the electrical contacts 142 within the electrical vias 144 electrically connects the body 116 of the ground shield 58 to the ground plane 42. Although not shown in FIG. 3, the electrical contacts 142 that extend from the inner walls 64 (FIGS. 6, 7, and 10) of the ground shield body 116 are received within electrical vias 144 that are located along the side 34 of the printed circuit 28 underneath the cable organizer body 66 and proximate corresponding slots 106 (FIGS. 4, 5, and 10). The inner walls 64 extend through the slots 106 such that the electrical contacts 142 extend outwardly from the inner walls 64 into the corresponding electrical via 144. In addition or alternatively to the electrical vias 144, the printed circuit 28 may include any other type of contact for electrical connection to the ground shield 58, such as, but not limited to, contact pads, an electrically conducive or non-electrically conductive via that receives a solder tail, an electrically conductive or non-electrically conductive via that receives another type of press-fit pin besides an eye-of-the needle compliant pin, a non-electrically conductive via that receives a press-fit pin, and/or the like.

The inner walls 64 of the ground shield body 116 are received within the slots 106 that extend into side 68 of the cable organizer body 66. FIG. 10 is a cross-sectional view of a portion of the electrical cable assembly 16 illustrating reception of one of the inner walls 64 within the corresponding slot 106. When the body 116 of the ground shield 58 is mounted over the cable organizer body 66, each inner wall 64 is received within the corresponding slot 106. Specifically, the inner walls 64 extend outwardly from the inner side 122 of the outer wall 118 of the ground shield body 116 into the corresponding slots 106 of the cable organizer body 66. As described above, in the exemplary embodiment, electrical contacts 142 extend from the inner walls 64 into the corresponding electrical vias 144 of the printed circuit 28 in electrical engagement therewith. When received within the corresponding slot 106, each inner wall 64 extends between two adjacent, and corresponding, channels 80 of the cable organizer body 66. Accordingly, each inner wall 64 extends between two adjacent, and corresponding, electrical cable ends 24.

The inner walls 64 facilitate shielding adjacent electrical cable ends 24 within the cable terminator assembly 30 from each other, which for example may facilitate reducing crosstalk between adjacent electrical cable ends 24 within the cable terminator assembly 30. In the exemplary embodiment, each electrical cable 20 includes two electrical conductors 40 that operate as a differential signal pair. Accordingly, in the exemplary embodiment, the inner walls 64 facilitate shielding adjacent differential signal pairs from each other, which for example may facilitate reducing crosstalk between adjacent differential signal pairs. Moreover, the inner walls 64 may facilitate providing a more accurate ground reference plane for impedance control.

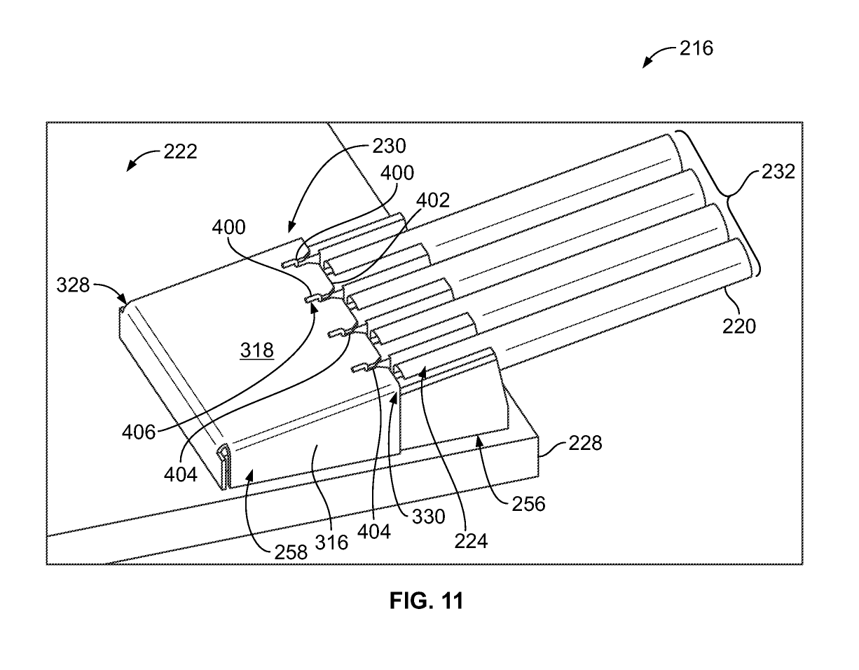

FIG. 11 is a perspective view of a portion of an exemplary alternative embodiment of an electrical cable assembly 216 illustrating an exemplary alternative embodiment of a cable terminator assembly 230. In the embodiment of FIG. 11, electrical cables 220 of the electrical cable assembly 216 include drain wires 400. The cable terminator assembly 230 includes a cable organizer 256 and a ground shield 258. The cable organizer 256 is mounted on a printed circuit 228 of an interposer assembly 222 that includes the cable terminator assembly 230. The cable organizer 256 holds and aligns ends 224 of a corresponding group 232 of the electrical cables 220 with corresponding electrical contacts (not shown) on the printed circuit 228. The ground shield 258 is mounted over the cable organizer 256.

The ground shield 258 includes a body 316 having an outer wall 318 that extends from an end 328 to an opposite end 330. The end 330 of the body 316 includes an edge 402. The outer wall 318 includes a plurality of openings 404. An end 406 of each drain wire 400 is received within a corresponding opening 404 and is electrically connected to the body 316 of the ground shield 258. Optionally, the ends 406 of the drain wires 400 are soldered or otherwise welded to the ground shield body 316.

In the exemplary embodiment, the openings 404 extend through the edge 402 of the ground shield body 316. Alternatively, the openings 404 do not extend through the edge 402 of the body 316. Moreover, in some alternative embodiments, the ends 406 of the drain wires 400 are electrically connected to the ground shield body 316 without being received within an opening 404 (whether or not the ground shield body 316 includes the openings 404.

The electrical cables 20 are shown and described herein as being twin axial cables that include two electrical conductors 40 that operate as a differential signal pair. However, the subject matter described and/or illustrated herein is not limited to twin axial cables, nor cables having two electrical conductors that operate as a differential signal pair. Rather, the subject matter described and/or illustrated herein may be used with any type of electrical cable having any number of electrical conductors, whether or not the electrical cable includes one or more differential signal pairs of electrical conductors, a cable jacket, one or more ground shields, one or more drain wires, and/or the like.

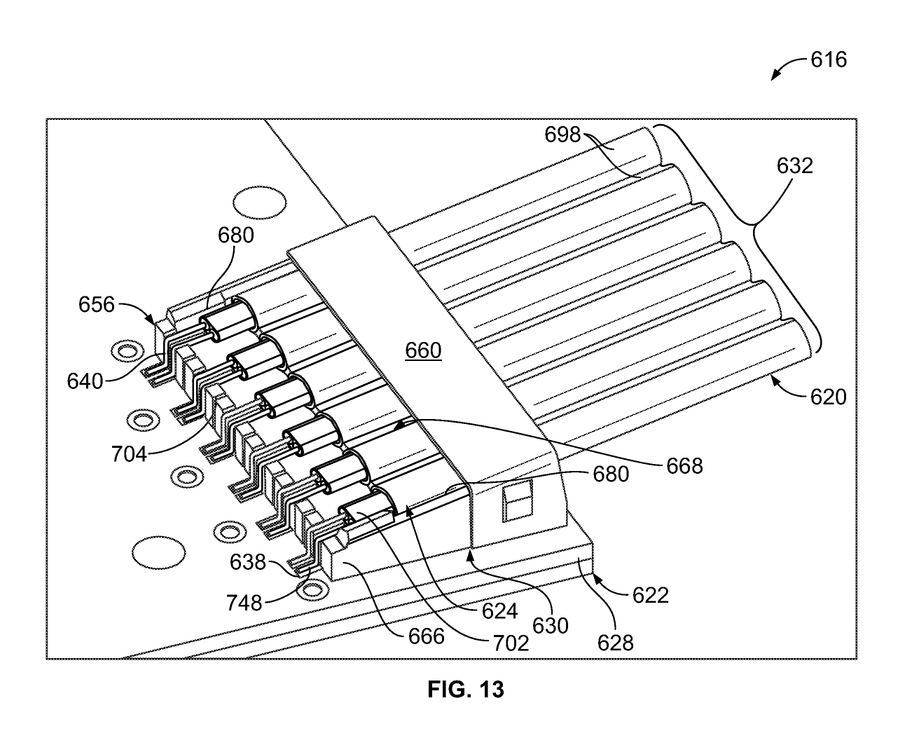

Moreover, the terms “electrical cables” and “plurality of electrical cables” as used herein are not limited to at least two cables having cable jackets that are separate and distinct from each other. Rather, the terms “electrical cables” and “plurality of electrical cables”, as used herein, include at least two cables (each having any number of electrical conductors) wherein the cable jackets thereof are connected together (whether or not the jackets are integrally formed as a single jacket of the cables), such as, but not limited to, in what is commonly referred to as a ribbon cable. Accordingly, the cable terminator assemblies 30 and 230 are not limited to terminating at least two cables having cable jackets that are separate and distinct from each other to a printed circuit. Rather, in some alternative embodiments, the cable terminator assemblies 30 and/or 230 may be used to terminate at least two cables (each having any number of electrical conductors) wherein the cable jackets thereof are connected together (whether or not the jackets are integrally formed as a single jacket of the cables). For example, FIG. 13 is an elevational view of a portion of an exemplary alternative embodiment of an electrical cable assembly 616. The electrical cable assembly 616 includes a ribbon cable 632, which includes a plurality of electrical cables 620 having cable jackets 698 that are connected together. Optionally, the cable jackets 698 are integrally formed as a single jacket 698 of the cables 620, as shown in FIG. 13. The electrical cable assembly 616 also includes an interposer assembly 622, which may electrically connect the electrical cables 620 to the electronic module 14 (FIG. 1). The interposer assembly 622 includes a printed circuit 628 and one or more cable terminator assemblies 630. Each cable terminator assembly 630 is used to terminate a corresponding ribbon cable 632 to the printed circuit 628.

The cable terminator assembly 630 includes a cable organizer 656, a ground shield (not shown), and an optional strain relief band 660. The ground shield has been removed from FIG. 13 for clarity. The cable organizer 656 is mounted on the printed circuit 628 of the interposer assembly 622. The cable organizer 656 includes a dielectric body 666 that includes a side 668, which may be referred to herein as a “cable side”. The body 666 of the cable organizer 656 holds ends 624 of the electrical cables 620 of the ribbon cable 632 along the side 668 of the body 666. For example, the body 666 includes one or more channels 680 that extend into the side 668 of the body 666. In the exemplary embodiment, the body 666 includes a single channel 680 that receives a portion of the length of the entire ribbon cable 632 therein. Alternatively, the body 66 includes a plurality of channels 680 that each receives a portion of the periphery of one or more corresponding electrical cables 620 of the ribbon cable 632. The body 666 includes optional conductor location slots 704 that are aligned in fluid communication with the channel 680. Each conductor location slot 104 receive a corresponding electrical conductor 640 of a corresponding one of the electrical cables 620 of the ribbon cable 632. Because each conductor location slot 704 is aligned with a corresponding electrical contact 638 of the printed circuit 628, an end 748 of each of the electrical conductors 640 is aligned with the corresponding electrical contact 638. The cable organizer 656 thereby holds and aligns electrical cable ends 624 of the corresponding ribbon cable 632 with the corresponding electrical contacts 638 of the printed circuit 628. The ends 748 of the electrical conductors 640 are terminated to the corresponding electrical contacts 638 of the printed circuit 628 such that the electrical conductors 640 are electrically connected to the corresponding electrical contacts 638. Optionally, the end 748 of one or more electrical conductors 640 is soldered to the corresponding electrical contact 638 of the printed circuit 628. In the exemplary embodiment, two conductor location slots 604 are aligned with each electrical cable 620 for receiving two electrical conductors 640 of the corresponding electrical cable 620. However, any number of conductor location slots 704 may be aligned with each electrical cable 620 for receiving any number of electrical conductors 640 of the corresponding electrical cable 620.

The ground shield of the assembly 630 is mounted over the cable organizer 656 such that an outer wall (not shown) of the ground shield extends over the ends 624 of the electrical cables 620. The ground shield of the assembly 630 may include inner walls (not shown) that extend between adjacent electrical cables 620 of the ribbon cable 632. Optionally, the body 666 of the cable organizer 656 includes slots (not shown) that receive corresponding ones of the inner walls of the ground shield therein. In some embodiments, the inner walls of the ground shield pierce the cable jacket 698 between the ends 624 of adjacent electrical cables 620 to extend between adjacent electrical cable ends 624 within the ribbon cable 632. In other embodiments, before mounting the ground shield on the cable organizer 656, the cable jacket 698 is removed (such as, but not limited to, using laser cutting and/or the like) between the ends 624 of adjacent electrical cables 620 to accommodate the inner walls of the ground shield. The ground shield of the assembly 630 may include electrical contacts (not shown) that engage the ground shields 702 of corresponding electrical cables 620 of the ribbon cable 632. The ground shield of the assembly 630 may include electrical contacts (not shown) that electrically connect the ground shield to the printed circuit 628.

Although the cable terminator assemblies 30, 230, and 630 are shown and described herein as terminating a plurality of respective electrical cables 20, 220, and 620 to a respective printed circuit 28, 228, and 628 of a respective interposer assembly 22, 222, and 622, the cable terminator assemblies 30, 230, and 630 are not limited to terminating electrical cables to the printed circuit of an interposer assembly, nor are the cable terminator assemblies 30, 230, and 630 limited to being used to electrically connect electrical cables to the substrate of an electronic module. Rather, the cable terminator assemblies 30, 230, and 630 may be used to terminate and/or electrically connect a plurality of electrical cables to any printed circuit, any substrate, and/or the like. For example, in some embodiments, the cable terminator assemblies 30, 230, and/or 630 are used to terminate a plurality of electrical cables directly to the substrate 18 of the electronic module 14. Another example of using the cable terminator assemblies 30, 230, and/or 630 includes using the cable terminator assemblies 30, 230, and/or 630 to terminate a plurality of electrical cables directly to the motherboard 12.

As used herein, the term “printed circuit” is intended to mean any electric circuit in which the conducting connections have been printed or otherwise deposited in predetermined patterns on an electrically insulating substrate. The printed circuits 28, 228, and 628 may each be a flexible member or a rigid member. The printed circuits 28, 228, and 628 may each be fabricated from and/or may include any material(s), such as, but not limited to, ceramic, epoxy-glass, polyimide (such as, but not limited to, Kapton® and/or the like), organic material, plastic, polymer, and/or the like. In some embodiments, the printed circuit 28, 228, and/or 628 is a rigid member fabricated from epoxy-glass, such that the printed circuit 28, 228, and/or 628 is what is sometimes referred to as a “circuit board” or a “printed circuit board”. In some embodiments, the printed circuit 28, 228, and/or 628 is fabricated from a ceramic material, such that the printed circuit 28, 228, and/or 628 is what is sometimes referred to as a “ceramic circuit”. In some embodiments, the printed circuit 28, 228, and/or 628 is fabricated from a plastic material, such that the printed circuit 28, 228, and/or 628 is what is sometimes referred to as a “plastic circuit”. The printed circuits 28, 228, and/or 628 may each, in some embodiments, be a hybrid circuit, a flex circuit, and/or a flat flex circuit. In some embodiments, the motherboard 12 and/or the substrate 18 is a printed circuit. The motherboard 12 and the substrate 18 may each be a flexible member or a rigid member, and may each be fabricated from any material(s).

The embodiments described and/or illustrated herein may enable an increase of the density of electrical contacts at the interconnection between the printed circuit of an interposer assembly and a plurality of electrical cables. The embodiments described and/or illustrated herein may provide an interposer assembly having a reduced amount of crosstalk, signal attenuation, and/or the like as compared with at least some known interposer assemblies. The embodiments described and/or illustrated herein may provide an interposer assembly having less impedance discontinuities between the interposer assembly and other components of an electronic system that includes the interposer assembly than at least some known interposer assemblies. The embodiments described and/or illustrated herein may provide an interposer assembly that is capable of handling increased data transmission rates while reducing or maintaining crosstalk, signal attenuation, and/or the like and/or while maintaining desired impedance values. For example, the embodiments described and/or illustrated herein may provide an interposer assembly that is capable of handling increased data transmission rates of at least 25 Gbps while reducing or maintaining crosstalk, signal attenuation, and/or the like and/or while maintaining desired impedance values.

It is to be understood that the above description is intended to be illustrative, and not restrictive. For example, the above-described embodiments (and/or aspects thereof) may be used in combination with each other. In addition, many modifications may be made to adapt a particular situation or material to the teachings of the invention without departing from its scope. Dimensions, types of materials, orientations of the various components, and the number and positions of the various components described herein are intended to define parameters of certain embodiments, and are by no means limiting and are merely exemplary embodiments. Many other embodiments and modifications within the spirit and scope of the claims will be apparent to those of skill in the art upon reviewing the above description. The scope of the subject matter described and/or illustrated herein should, therefore, be determined with reference to the appended claims, along with the full scope of equivalents to which such claims are entitled. In the appended claims, the terms “including” and “in which” are used as the plain-English equivalents of the respective terms “comprising” and “wherein.” Moreover, in the following claims, the terms “first,” “second,” and “third,” etc. are used merely as labels, and are not intended to impose numerical requirements on their objects. Further, the limitations of the following claims are not written in means—plus-function format and are not intended to be interpreted based on 35 U.S.C. §112, sixth paragraph, unless and until such claim limitations expressly use the phrase “means for” followed by a statement of function void of further structure.

What is claimed is:

1. An interposer assembly for electrically connecting electrical cables to an electronic module, said interposer assembly comprising:
a printed circuit comprising an electrical connector configured to electrically connect the printed circuit to the electronic module;
a cable organizer mounted on the printed circuit and comprising a dielectric body having a cable side, the cable organizer being configured to hold the electrical cables along the cable side of the body; and
an electrically conductive ground shield mounted over the body of the cable organizer, the ground shield comprising an outer wall that extends over the cable side of the body of the cable organizer such that the outer wall is configured to extend over the electrical cables.

2. The interposer assembly according to claim 1, wherein the body of the cable organizer comprises channels that are configured to hold corresponding electrical cables therein, the ground shield comprising an inner wall that extends between the channels such that the inner wall is configured to extend between the corresponding electrical cables.

3. The interposer assembly according to claim 1, wherein the ground shield comprises an interior chamber having at least a portion of the cable organizer received therein, the ground shield further comprising an inner wall that extends from the outer wall and divides the interior chamber of the ground shield into tunnels that are configured to receive corresponding electrical cables therein.

4. The interposer assembly according to claim 1, wherein the body of the cable organizer comprises a printed circuit side that faces the printed circuit, the body comprising opposite end walls that extend from the printed circuit side to the cable side, the ground shield comprising side walls that extend from the outer wall and over corresponding end walls of the body of the cable organizer.

5. The interposer assembly according to claim 1, wherein the printed circuit comprises a ground plane, the ground shield being electrically connected to the ground plane.

6. The interposer assembly according to claim 1, wherein the printed circuit comprises an electrical via, the ground shield comprising a pin that is received within the electrical via such that the ground shield is electrically connected to the printed circuit.

7. The interposer assembly according to claim 1, wherein the electrical cables include drain wires, the ground shield comprising openings that are configured to receive corresponding drain wires therein.

8. The interposer assembly according to claim 1, wherein the electrical cables include electrically conductive cable shields, the outer wall of the ground shield comprising electrical contacts having resiliently deflectable cantilever beams that are configured to engage corresponding cable shields to electrically connect the ground shield to the cable shields.

9. The interposer assembly according to claim 1, wherein the electrical cables include twin axial cables.

10. An electrical cable assembly comprising:
electrical cables; and
an interposer assembly for electrically connecting the electrical cables to an electronic module, said interposer assembly comprising:
a printed circuit comprising an electrical connector configured to electrically connect the printed circuit to the electronic module, the electrical cables being electrically connected to the printed circuit;
a cable organizer mounted on the printed circuit and comprising a dielectric body holding the electrical cables; and
an electrically conductive ground shield mounted over the body of the cable organizer, the ground shield comprising an outer wall that extends over the electrical cables.

11. The assembly according to claim 10, wherein the body of the cable organizer comprises a slot, the ground shield comprising an inner wall that extends within the slot and between corresponding electrical cables.

12. The assembly according to claim 10, wherein the electrical cables comprise electrical conductors and the printed circuit comprises electrical contacts, the electrical cables being held by the cable organizer such that the electrical conductors are aligned with corresponding electrical contacts of the printed circuit, the electrical conductors being electrically connected to the corresponding electrical contacts of the printed circuit.

13. The assembly according to claim 10, wherein the electrical cables comprise drain wires, the ground shield being electrically connected to the drain wires.

14. The assembly according to claim 10, wherein the electrical cables comprise electrically conductive cable shields, the outer wall of the ground shield comprising electrical contacts having resiliently deflectable cantilever beams that are engaged with corresponding cable shields such that the ground shield is electrically connected to the cable shields.

15. An interposer assembly for electrically connecting electrical cables to an electronic module, the electrical cables having electrical conductors, said interposer assembly comprising:
a printed circuit comprising an electrical connector configured to electrically connect the printed circuit to the electronic module, the printed circuit further comprising electrical contacts that are configured to be electrically connected to corresponding electrical conductors of the electrical cables; and
a cable organizer mounted on the printed circuit and comprising a dielectric body, the body comprising channels that are configured to hold corresponding electrical cables therein, the channels being arranged along the body in alignment with corresponding electrical contacts of the printed circuit.

16. The interposer assembly according to claim 15, wherein at least one of the channels comprises a shape that is complementary with a shape of the corresponding electrical cable.

17. The interposer assembly according to claim 15, wherein the body of the cable organizer comprises slots that extend into the body between adjacent channels.

18. The interposer assembly according to claim 15, wherein the body of the cable organizer comprises conductor location slots that are aligned in fluid communication with corresponding channels and are configured to receive corresponding electrical conductors of the electrical cables therein, the conductor location slots being aligned with corresponding electrical contacts of the printed circuit.

19. The interposer assembly according to claim 15, wherein the printed circuit comprises an organizer side along which the body of the cable organizer is mounted, the body of the cable organizer comprising a cable side along which the electrical cables are held, the cable side of the body of the cable organizer extending along a slope relative to the organizer side of the printed circuit.

20. The interposer assembly according to claim 15, wherein the body of the cable organizer comprises a cable side along which the electrical cables are configured to be held, the interposer assembly further comprising a strain relief band mounted on the body of the cable organizer and extending over the cable side of the body such that the strain relief band is configured to extend over the electrical cables.
